(19) United States
(12) Patent Application Publication
(10) Pub. No.: US 2025/0092546 A1
(43) Pub. Date: Mar. 20, 2025

(54) METHOD FOR PREPARING ONE-DIMENSIONAL Ni12P5/Ni2P POLYCRYSTALLINE HETEROSTRUCTURE CATALYST USED FOR EFFICIENCY WATER OXIDATION

(71) Applicant: DALIAN INSTITUTE OF CHEMICAL PHYSICS, CHINESE ACADEMY OF SCIENCES, Dalian, Liaoning (CN)

(72) Inventors: Fuxiang ZHANG, Dalian, Liaoning (CN); Rashid MEHMOOD, Dalian, Liaoning (CN); Xiangyang GUO, Dalian, Liaoning (CN); Wenjun FAN, Dalian, Liaoning (CN)

(21) Appl. No.: 18/726,916

(22) PCT Filed: Jun. 28, 2023
(86) PCT No.: PCT/CN2023/103043

§ 371 Date: Jul. 5, 2024

(30) Foreign Application Priority Data
Jul. 1, 2022 (CN) 202210775701.7

(51) Int. Cl. C25B 11/091; C23C 18/04; C23C 18/12; C25B 1/04; C25B 11/031; C25B 11/052; C25B 11/061

(52) U.S. Cl. CPC C25B 11/091; C23C 18/04; C23C 18/1204; C23C 18/125; C25B 1/04; C25B 11/031; C25B 11/052; C25B 11/061

(57) ABSTRACT

A preparation method for a one-dimensional Ni₁₂P₅/Ni₂P polycrystalline heterostructure catalyst used for high-efficiency water oxidation is provided. In particular, nickel foam is used as a conductive carrier and a nickel source, sodium phosphite is used as a phosphorus source, and the one-dimensional polycrystalline heterostructure catalyst is synthesized therefrom by means of a two-step hydrothermal-phosphorization method. The combination of the one-dimensional heterostructure and the nickel foam conductive carrier is beneficial for charge transfer and the release of bubbles on the surface of an electrode/electrolyte. The prepared Ni₁₂P₅/Ni₂P/NF catalyst has a relatively low electrocatalytic water oxidation overpotential and long-term stability in an alkaline solution. After the Ni₁₂P₅/Ni₂P/NF is loaded with monatomic Ir, the water oxidation overpotential can be further reduced.

### TECHNICAL FIELD

The present invention relates to the technical field of catalytic materials, and in particular to a method for preparing a one-dimensional Ni₁₂P₅/Ni₂P polycrystalline heterostructure catalyst used for high-efficiency water oxidation.

### BACKGROUND

The huge development in global economy and human society highly depends on fossil fuels, inevitably leading to an increasingly serious energy crisis and environmental problems. In order to solve these problems, people have done a lot of studies in the fields of electrolyte, rechargeable metal-air batteries, fuel cells, water electrolysis and other electrochemical systems to produce renewable hydrogen energy. However, the electrochemical performance of the above-mentioned systems for producing renewable hydrogen is greatly limited by oxygen evolution reaction (OER). This is due to slow OER kinetics generated by the multi-reaction intermediates during the OER process, resulting in large overpotential and significant energy efficiency loss. Therefore, a lot of studies have been done to prepare OER catalysts with high activity, high stability and low cost. Although noble metal-based electrocatalysts have excellent water electrolysis performance, they are scarce in content and low in stability in alkaline water electrolysis systems, which are not ideal commercial catalysts.

In recent years, metal-free and single-atom dispersed OER electrocatalysts (such as transition metal-based chalcogenides, borides, carbides, nitrides, phosphides, etc.) with high activity, good stability, and low cost has become a research focus of scientists. However, the electrocatalytic performance of such non-noble metal OER catalysts is far from meeting the requirements of industrial applications. Meanwhile, poor conductivity and small specific surface area of such non-noble metal OER catalysts greatly hinder the charge transfer inside the catalyst material and the contact between the electrolyte and the active sites on the surface of the catalyst. Among the above-mentioned materials, the transition metal-based phosphides (TMPs) are considered to be one of the most promising electrocatalysts due to their high conductivity and easy-to-adjust electronic structure. However, the high ionic characteristics of the electropositive metal (M includes Co, Ni, Fe, etc.) atoms and the highly electronegative non-metallic P atoms in the TMPs weaken the electron delocalization ability, resulting in low electrocatalytic activity and poor stability of TMPs. It is well known that one-dimensional nanomaterials have wide applications in reducing overpotential since their high electrochemical active specific surface area, rapid charging, and efficient transport characteristics of reactive species. In addition, studies have shown that nanorod structure can not only promote interface electron transfer by improving electron transfer on the surface of a substrate, but also facilitate the release of bubbles on the surface of an electrode/electrolyte. Recently, strategies such as element doping, oxygen or phosphorus vacancies, crystal facet engineering, and interface engineering have been widely used for the preparation of high-performance one-dimensional electrocatalytic materials. Among them, interface engineering has become one of the most effective strategies to improve the electrocatalytic activity and stability of water splitting. Although some progress has been made in the research of TMPs-based electrocatalysts for water splitting, there remains a lack of TMPs-based electrocatalytic systems with low overpotential, high stability and long service life. It should be noted that one-dimensional materials not only have good catalytic performance, but also can be used as effective carrier materials for electrocatalysis. It can be seen that the preparation of TMPs materials with unique one-dimensional polycrystalline heterostructure on nickel foam carrier is an effective way to obtain OER electrocatalysts with good activity and high stability.

### SUMMARY OF THE INVENTION

In order to solve the above technical problems, the present invention provides a method for preparing a one-dimensional Ni₁₂P₅/Ni₂P polycrystalline heterostructure catalyst used for high-efficiency water oxidation. The present invention mainly uses commercial nickel foam (NF) with low price as a conductive carrier and a nickel source, and the one-dimensional Ni₁₂P₅/Ni₂P/NF polycrystalline heterostructure catalyst is obtained by means of a two-step hydrothermal-phosphorization method. The two-step hydrothermal-phosphorization method increases the roughness and defect degree of surface of the nickel foam. The heterostructure and interface in the Ni₁₂P₅/Ni₂P/NF catalyst skillfully regulate the electronic structures of Ni and P ions in the electrocatalyst, which is conducive to reducing the energy barrier of rate-limiting step. In addition, the one-dimensional polycrystalline heterostructure facilitates the adsorption of water molecules at catalytic sites and desorption of oxygen from the catalyst surface. Moreover, the tight connection between the polycrystalline heterostructure electrocatalyst and the nickel foam carrier effectively prevents the stripping of the catalyst in the reaction process, thereby achieving long-term stability in the alkaline electrolyte.

Technical solutions adopted in the present invention are as follows: a method for preparing a one-dimensional Ni₁₂P₅/Ni₂P polycrystalline heterostructure catalyst used for high-efficiency water oxidation takes low cost commercial NF as conductive carrier and nickel source, takes phosphite as phosphorous source, and obtains the one-dimensional Ni₁₂P₅/Ni₂P/NF polycrystalline heterostructure catalyst by means of a two-step hydrothermal-phosphorization method. The phosphite is NaH₂PO₂·H₂O.

The preparation method includes the following steps of:
S1. Cutting the nickel foam (NF) into an appropriate size and applying light pressing to thin it, putting the NF into a HCl solution with a concentration of 1.0-4.0 M for ultrasonic treatment for 20-60 min, then performing ultrasonic washing to the NF in deionized water, ethanol and acetone for 20-40 min in sequence, and vacuum drying the washed NF in a vacuum drying oven at 50-70° C. for 24-36 h to obtain a clean NF sheet for later use.
S2. Preparing a (NH4)₂HPO₄ aqueous solution, putting the clean NF sheet obtained in step S1 into the (NH4)₂HPO₄ aqueous solution for solvothermal reaction at a reaction temperature of 170-190° C. for 10-16 h to obtain a reacted NF sheet, naturally cooling the reacted NF sheet to room temperature, washing the reacted NF sheet with deionized water, and then vacuum drying the reacted NF sheet after washing in a vacuum drying oven at 50-70° C. for 10-16 h, putting the dried NF sheet into a NaOH aqueous solution for solvothermal reaction at 100-130° C. for 4-6 h to obtain a reaction product, washing and drying the reaction product to obtain a NF sheet with rough and defective surface (r-NF) for later use.
S3. Mixing NaH₂PO₂·H₂O and the r-NF obtained in step S2 according to a weight ratio to

obtain a mixture, putting the mixture in a porcelain boat and then placing the porcelain boat into a quartz tube, heating the quartz tube in a tubular furnace at a temperature of 270-380° C. for 2-4 h under a nitrogen atmosphere to obtain a product after naturally cooling to room temperature, washing and drying the product to obtain the target material of Ni₁₂P₅/Ni₂P/NF catalyst.

Based on the above solution, in step S1, preferably the size of the NF is 3×3 cm² to 6×6 cm².

Based on the above solution, in step S2, preferably the (NH4)₂HPO₄ aqueous solution has a concentration of 1-2 mM, and the NaOH aqueous solution has a concentration of 100-200 mM.

Based on the above solution, in step S3, preferably the weight ratio of NaH₂PO₂·H₂O to r-NF obtained in step S2 is 9-11:1.

Based on the above solution, in step S3, preferably a flow rate of nitrogen is 100-150 sccm, a heating rate is 5-8° C./min, the heating temperature is 270-380° C. to prepare the material of Ni₁₂P₅/Ni₂P/NF-T, where T represents the heating temperature, and preferably can be 75° C., 300° C., 325° C., 350° C., 375° C.

Based on the above solution, in step S3, preferably the flow rate of nitrogen is 150 sccm, the heating rate is 5° C./min, the heating temperature is 400° C., and the material of Ni₁₂P₅/NF is obtained after naturally cooling, washing and drying the product naturally cooling, washing and dying.

Based on the above solution, in step S3, preferably the flow rate of nitrogen is 150 sccm, the heating rate is 5° C./min, the heating temperature is 250° C., and the material of Ni₂P/NF is obtained after naturally cooling, washing and dying.

Based on the above solution, in step S3, preferably the NaH₂PO₂·H₂O is placed upstream of the porcelain boat and the r-NF obtained in step S2 is placed downstream of the porcelain boat, the weight ratio of NaH₂PO₂·H₂O to r-NF is 9-11:1, the flow rate of nitrogen is 150 sccm, the heating rate is 5° C./min, the heating temperature is 250° C., and the material of Ni₂P/NF is obtained after naturally cooling, washing and drying.

Based on the above solution, in step S3, preferably the drying conditions are as follows: vacuum drying at room temperature for 12-24 h.

Based on the above solution, based on the Ni₁₂P₅/Ni₂P/NF catalyst prepared by the above solution, preferably an ethanol/aqueous solution of potassium hexachloroiridate is prepared and drop-coated on the Ni₁₂P₅/Ni₂P/NF catalyst, then heat the catalyst at 60-90° C. to obtain an Ir—Ni₁₂P₅/Ni₂P/NF-275 catalyst after naturally cooling to room temperature.

Based on the above solution, preferably, the concentration of the potassium hexachloroiridate solution has a concentration of 0.02-0.04 mM, the solvent thereof is a mixture of ethanol and water with a volume ratio of 1:1-2, and a mass ratio of Ir to Ni₁₂P₅/Ni₂P/NF catalyst in the Irₓ—Ni₁₂P₅/Ni₂PF-T material is 0.01-0.04:1, where x=1-4, such as 1, 2, 3 or 4.

In another aspect, the present invention provides an application of the above-mentioned catalyst in electrocatalytic water splitting oxygen evolution. The reaction conditions including directly using the obtained Ni₁₂P₅/Ni₂P/NF-T, NI₁₂P₅/NF, Ni₂P/NF or Ir—Ni₁₂P₅/Ni₂P/NF catalysts as oxygen evolution electrodes for the electrocatalytic water splitting reaction by means of a two-electrode system.

Based on the above solution, preferably, the electrolyte used in the electrocatalytic water splitting reaction is an alkaline electrolyte, and a base for the alkaline electrolyte is one of KOH, NaOH, LiOH and CsOH, preferably KOH; and a concentration of the alkaline electrolyte is 0.5-10 M, preferably 1 M.

Beneficial effects of the present invention:

The one-dimensional Ni₁₂P₅/Ni₂P polycrystalline heterostructure catalyst used for high-efficiency water oxidation provided in the present invention has the advantages of low raw material price, simple and convenient synthesis method, stable chemical properties, and the electrode formed by the catalyst has robust structure, superior OER activity and stability, which is easy to be popularized and applied. The one-dimensional polycrystalline heterostructure catalyst is synthesized by means of a two-step hydrothermal-phosphorization method using NF as a conductive carrier and a nickel source, which can effectively solve the problems of TMPs catalysts in the prior art, such as large overpotential, poor internal charge transfer, instability, prone to peeling off and the like. In addition, the one-dimensional heterostructure is tightly combined with the conductive carrier NF, which is beneficial for charge transfer and the release of bubbles on the surface of the electrode/electrolyte. For electrocatalytic water oxidation reaction in an alkaline solution, the prepared Ni₁₂P₅/Ni₂P/NF catalyst in the present invention has relatively low electrocatalytic water oxidation overpotential and long-term stability. The prepared Ni₁₂P₅/Ni₂P/NF catalyst in the present invention has an overpotential of 254 mV at a current density of 10 mA/cm², and its performance is better than that of the currently best RuO₂ catalyst (overpotential of 295 mV), and the corresponding Ni₂P/NF (overpotential of 278 mV) and Ni₁₂P₅/NF (overpotential of 288 mV). The prepared Ni₁₂P₅/Ni₂P/NF catalyst in the present invention has a stability of 200 h at a current density of 50 mA/cm². When the Ni₁₂P5/Ni₂P/NF polycrystalline heterostructure is loaded with monatomic Ir, the water oxidation overpotential can be further reduced. The overpotential can be further reduced to 196 mV at a current density of 10 mA/cm², while maintaining the stability for more than 100 h at a current density of 50 mA/cm². This two-step hydrothermal-phosphorization method using commercial NF as a precursor shows broad application prospects in the synthesis of alkaline OER electrocatalysts.

Based on the above reasons, the present invention can be widely popularized in the fields of water splitting electrocatalytic materials and the like.

### DETAILED DESCRIPTION OF DRAWINGS

FIG. 1 shows a transmission electron microscope (TEM) diagram of a target material Ni₁₂P₅/Ni₂P/NF-275.

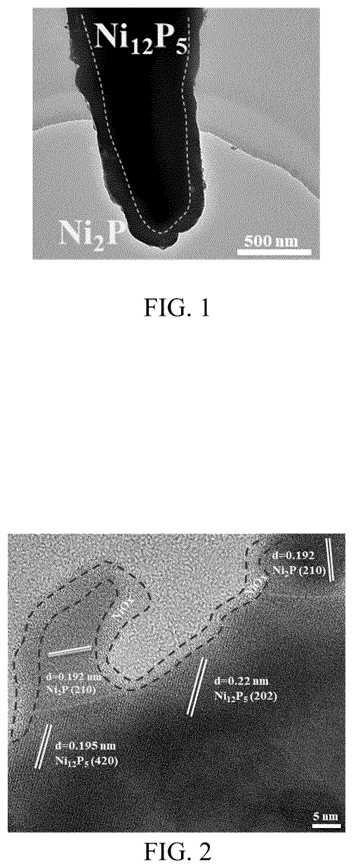

FIG. 2 shows a high resolution transmission electron microscope (HRTEM) diagram of a target material Ni₁₂P₅/Ni₂P/NF-275.

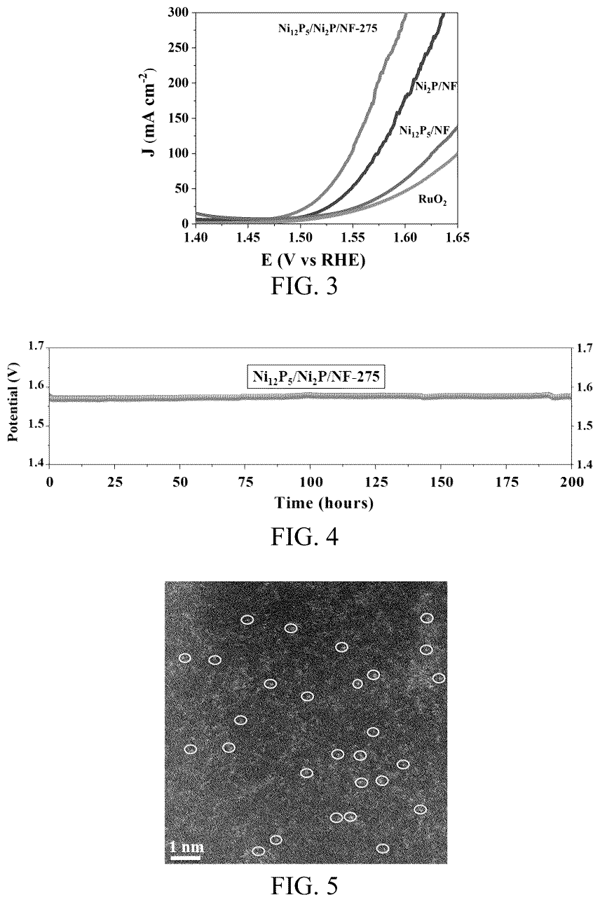

FIG. 3 shows LSV polarization curves of target materials Ni₁₂P₅/Ni₂P/NF-275, Ni₁₂P₅/NF, Ni₂P/NF and RuO₂/NF.

FIG. 4 shows a stability test diagram of a target material Ni₁₂P₅/Ni₂P/NF-275 at a current density of 50 mA/cm² (with a test time of 200 h).

FIG. 5 shows a high-angle annular dark-field—scanning transmission electron microscopy (HAADF-STEM) diagram of a target material 3% Ir—Ni₁₂P₅/Ni₂P/NF-275.

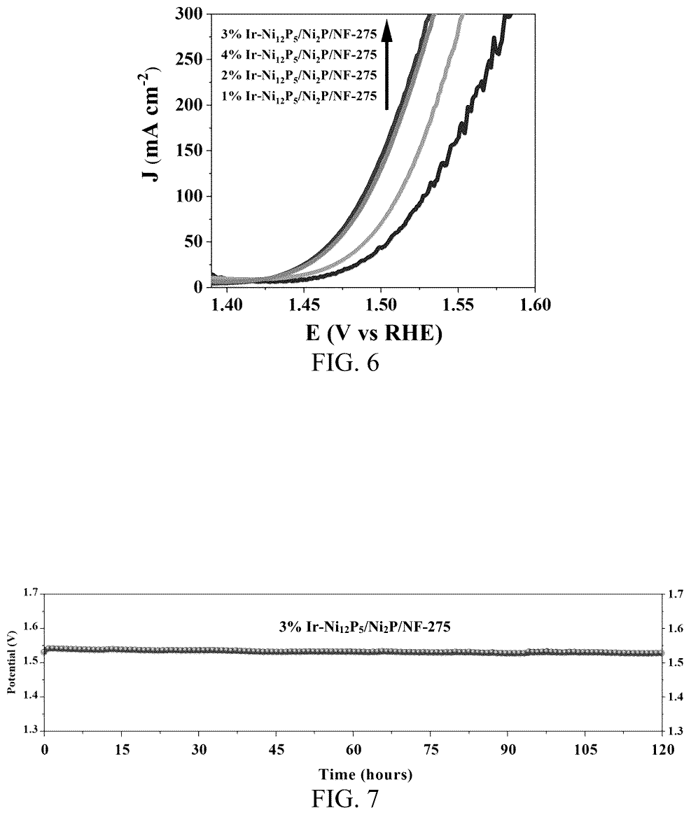

FIG. 6 shows LSV polarization curves of target materials x % Ni₁₂P₅/Ni₂P/NF-275.

FIG. 7 shows a stability test diagram of a target material 3% Ir—Ni₁₂P₅/Ni₂P/NF-275 at a current density of 50 mA/cm² (with a test time of 120 h).

### DETAILED DESCRIPTION OF PREFERRED EMBODIMENTS

In order to further describe the present invention, the following embodiments are illustrated in combination with the accompanying drawings, but it does not limit the scope of the present invention as defined in the claims.

### Embodiment 1

S1. A nickel foam (NF) was cut into 3×3 cm² and was lightly pressed to thin it, the thinned NF was put into a 3.0 M HCl solution for ultrasonic treatment for 30 min, then the NF was ultrasonic washed in deionized water, ethanol and acetone for 30 min in sequence, the washed NF was put into a vacuum drying oven at 60° C. for 24 h to obtain a clean NF sheet for later use.

S2. 1 nM of a (NH4)₂HPO₄ aqueous solution was prepared, the NF sheet obtained in step S1 was put into the (NH4)₂HPO₄ aqueous solution for solvothermal reaction at a reaction temperature of 160°° C. for 12 h to obtain a reacted NF sheet. The reacted NF sheet was naturally cooled to room temperature, and then was washed with deionized water and vacuum dried in a vacuum drying oven at 60° C. for 12 h. The dried NF sheet was put into a 100 mM NaOH aqueous solution for solvothermal reaction at 120° C. for 5 h to obtain a reaction product. The reaction product was washed with deionized water, and then put into a vacuum dying oven to dry overnight at room temperature to obtain a NF sheet with rough and defective surface (r-NF) for later use.

S3. NaH₂PO₂·H₂O and the r-NF obtained in step S2 were mixed with a weight ratio of 10:1 to obtain a mixture, the mixture was put in a porcelain boat, and then the porcelain boat was placed into a quartz tube, and the quartz tube was heated at 275° C. for 2 h in a tubular furnace under a nitrogen atmosphere (with a nitrogen flow rate of 150 sccm and a heating rate of 5° C./min) to obtain a product after naturally cooling to room temperature. The product was washed with deionized water, and then put into the vacuum dying oven to dry overnight at room temperature to obtain a target material Ni₁₂P₅/Ni₂P/NF-275.

Structural characterization of the target material: TEM diagram (FIG. 1) and HRTEM diagram (FIG. 2) show that the target material has a polycrystalline heterostructure. It was observed that the crystal lattice fringe spacing of 0.192 nm corresponds to the (210) crystal face of Ni₂P and the crystal lattice fringe spacing of 0.195 nm and 0.22 nm respectively correspond to the (420) crystal face and (202) crystal face of Ni₁₂P₅.

Electrochemical test of Ni₁₂P₅/Ni₂P/NF-275 catalyst: the electrochemical performance of the target material was tested on an electrochemical workstation, using a graphite rod as counter electrode and an Hg/Hgo electrode (KOH, 1M) as reference electrode. According to the Nernst equation, each of the potentials tested herein was calibrated to reversible hydrogen electrode (RHE), and E(RHE)=0.098+E(HG/HGO)+0.0592×pH. A polarization curve was recorded at a scan rate of 1 mV/s in an O₂-saturated KOH (1M) electrolyte. The polarization curve and Tafel slope were applied with 90% iR-compensation. An electrochemical double-layer capacitance was measured in a potential range of 0.9 V-1.02 V (vs. Hg/HgO) at different scan rates by means of cyclic voltammetry (CV). The electrochemical impedance spectroscopy (EIS) test recorded data in a range of 0.1 Hz to 100 KHz at the potential of 1.53 V (vs. RHE). Stability test used chronoamperometry under a condition of I=50 mA/cm². The obtained polarization curve, double-layer capacitance diagram, EIS, and stability test are shown as FIGS. 3-4. It can be seen from the polarization curve (FIG. 3) that the corresponding overpotential at the current density of I=50 mA/cm² was 254 mV, which is superior to the same kind of materials of Ni₁₂P₅/NF , Ni₂P/NF and commercial RuO₂/NF; and the corresponding overpotential at the current density of 50 mA/cm² was 295 mV. The stability test results show that the catalyst was stable during a test period of 200 h at the current density of 50 mA/cm² (FIG. 4).

### Embodiment 2

Preparation process of r-NF was the same as that of Embodiment 1.

NaH₂PO₂·H₂O and the obtained r-NF were mixed with a weight ratio of 10:1 to obtain a mixture, the mixture was put in a porcelain boat, and then the porcelain boat was placed into a quartz tube, and the quartz tube was heated at 300° C. for 2 h in a tubular furnace under a nitrogen atmosphere (with a nitrogen flow rate of 150 sccm and a heating rate of 5° C./min) to obtain a product after naturally cooling. The product was washed with deionized water, and then put into the vacuum dying oven to dry overnight at room temperature to obtain a target material Ni₁₂P₅/Ni₂P/NF-300.

The electrochemical test conditions were the same as those in Embodiment 1, and the electrochemical test performance is shown in FIG. 3. The electrochemical test results show that the corresponding overpotential at the current density of 50 mA/cm² was 324 mV.

### Embodiment 3

Preparation process of r-NF was the same as that of Embodiment 1.

NaH₂PO₂·H₂O and the obtained r-NF were mixed with a weight ratio of 10:1 to obtain a mixture, the mixture was put in a porcelain boat, and then the porcelain boat was placed into a quartz tube, and the quartz tube was heated at 325° C. for 2 h in a tubular furnace under a nitrogen atmosphere (with a nitrogen flow rate of 150 sccm and a heating rate of 5° C./min) to obtain a product after naturally cooling. The product was washed with deionized water, and then put into the vacuum dying oven to dry overnight at room temperature to obtain a target material Ni₁₂P₅/Ni₂P/NF-325.

The electrochemical test conditions were the same as those in Embodiment 1, and the electrochemical test performance is shown in FIG. 3. The electrochemical test results show that the corresponding overpotential at the current density of 50 mA/cm² was 330 mV.

### Embodiment 4

Preparation process of r-NF was the same as that of Embodiment 1.

NaH₂PO₂·H₂O and the obtained r-NF were mixed with a weight ratio of 10:1 to obtain a mixture, the mixture was put in a porcelain boat, and then the porcelain boat was placed into a quartz tube, and the quartz tube was heated at 350° C. for 2 h in a tubular furnace under a nitrogen atmosphere (with a nitrogen flow rate of 150 sccm and a heating rate of 5° C./min) to obtain a product after naturally cooling. The product was washed with deionized water, and then put into the vacuum dying oven to dry overnight at room temperature to obtain a target material Ni₁₂P₅/Ni₂P/NF-350.

The electrochemical test conditions were the same as those in Embodiment 1, and the electrochemical test performance is shown in FIG. 3. The electrochemical test results show that the corresponding overpotential at the current density of 50 mA/cm² was 340 mV.

### Embodiment 5

Preparation process of r-NF was the same as that of Embodiment 1.

NaH₂PO₂·H₂O and the obtained r-NF were mixed with a weight ratio of 10:1 to obtain a mixture, the mixture was put in a porcelain boat, and then the porcelain boat was placed into a quartz tube, and the quartz tube was heated at 375° C. for 2 h in a tubular furnace under a nitrogen atmosphere (with a nitrogen flow rate of 150 sccm and a heating rate of 5° C./min) to obtain a product after naturally cooling. The product was washed with deionized water, and then put into the vacuum dying oven to dry overnight at room temperature to obtain a target material Ni₁₂P₅/Ni₂P/NF-375.

The electrochemical test conditions were the same as those in Embodiment 1, and the electrochemical test performance is shown in FIG. 3. The electrochemical test results show that the corresponding overpotential at the current density of 50 mA/cm² was 351 mV.

### Embodiment 6

An ethanol/aqueous solution (with a volume ratio of 1:1) of potassium hexachloroidate with a concentration of 0.02 nM was prepared, and 100 μL of the prepared potassium hexachloroidate solution was drop-coated on the Ni₁₂P₅/Ni₂P/NF-275 catalyst prepared in Embodiment 1, then the catalyst was heated at 70°° C. for 2 h, and a target 1% Ir—Ni₁₂P₅/Ni₂P/NF-275 catalyst was obtained after naturally cooling to room temperature.

The electrochemical test conditions were the same as those in Embodiment 1, and the electrochemical test performance is shown in FIG. 6. The electrochemical test results show that the corresponding overpotential at the current density of 10 mA/cm² was 230 mV, and the corresponding overpotential at the current density of 50 mA/cm² was 274 mV.

### Embodiment 7

An ethanol/aqueous solution (with a volume ratio of 1:1) of potassium hexachloroidate with a concentration of 0.02 nM was prepared, and 200 μL of the prepared potassium hexachloroidate solution was drop-coated on the Ni₁₂P₅/Ni₂P/NF-275 catalyst prepared in Embodiment 1, then the catalyst was heated at 70°° C. for 2 h, and a target 2% Ir—Ni₁₂P₅/Ni₂P/NF-275 catalyst was obtained after naturally cooling to room temperature.

The electrochemical test conditions were the same as those in Embodiment 1, and the electrochemical test performance is shown in FIG. 6. The electrochemical test results show that the corresponding overpotential at the current density of 10 mA/cm² was 210 mV, and the corresponding overpotential at the current density of 50 mA/cm² was 258 mV.

### Embodiment 8

An ethanol/aqueous solution (with a volume ratio of 1:1) of potassium hexachloroidate with a concentration of 0.02 nM was prepared, and 300 μL of the prepared potassium hexachloroidate solution was drop-coated on the Ni₁₂P₅/Ni₂P/NF-275 catalyst prepared in Embodiment 1, then the catalyst was heated at 70° C. for 2 h, and a target 3% Ir—Ni₁₂P₅/Ni₂P/NF-275 catalyst was obtained after naturally cooling to room temperature.

The target material 3% Ir—Ni₁₂P₅/Ni₂P/NF-275 has a one-dimensional polycrystalline heterostructure. It can be seen from the HAADF-STEM diagram (FIG. 5) that Ir was monoatomically dispersed in the Ni₁₂P₅/Ni₂P/NF-275 catalyst.

The electrochemical test conditions were the same as those in Embodiment 1, and the electrochemical test performance is shown in FIG. 6. The electrochemical test results show that the corresponding overpotential at the current density of 10 mA/cm² was 199 mV, and the corresponding overpotential at the current density of 50 mA/cm² was 239 mV. The stability test results show that the catalyst was stable during a test period of 120 h at a current density of 50 mA/cm² (FIG. 7).

### Embodiment 9

An ethanol/aqueous solution (with a volume ratio of 1:1) of potassium hexachloroidate with a concentration of 0.02 nM was prepared, and 400 μL of the prepared potassium hexachloroidate solution was drop-coated on the Ni₁₂P₅/Ni₂P/NF-275 catalyst prepared in Embodiment 1, then the catalyst was heated at 70° C. for 2 h, and a target 4% Ir—Ni₁₂P₅/Ni₂P/NF-275 catalyst was obtained after naturally cooling to room temperature.

The electrochemical test conditions were the same as those in Embodiment 1, and the electrochemical test performance is shown in FIG. 6. The electrochemical test results show that the corresponding overpotential at the current density of 10 mA/cm² was 200 mV, and the corresponding overpotential at the current density of 50 mA/cm² was 240 mV.

### Comparative Example 1

Control experiment on electrochemical water oxidation of non-heterostructure Ni₁₂P₅/NF catalyst

Preparation process of r-NF was the same as that of Embodiment 1.

NaH₂PO₂·H₂O and the obtained r-NF were mixed with a weight ratio of 10:1 to obtain a mixture, the mixture was put in a porcelain boat, and then the porcelain boat was placed into a quartz tube, and the quartz tube was heated at 400° C. for 2 h in a tubular furnace under a nitrogen atmosphere (with a nitrogen flow rate of 150 sccm and a heating rate of 5° C./min) to obtain a product after naturally cooling. The product was washed and dried to obtain a target material Ni₁₂P₅/NF.

The electrochemical test conditions were the same as those in Embodiment 1, and the electrochemical test performance is shown in FIG. 3. The electrochemical test results show that the corresponding overpotential at the current density of 10 mA/cm² was 288 mV, and the corresponding overpotential at the current density of 50 mA/cm² was 358 mV.

### Comparative Example 2

Control experiment on electrochemical water oxidation of non-heterostructure Ni₂P/NF catalyst

Preparation process of r-NF was the same as that of Embodiment 1.

NaH₂PO₂·H₂O was placed upstream of the porcelain boat, r-NF was placed downstream of

the porcelain boat, and the weight ratio of NaH₂PO₂·H₂O to r-NF was 10:1. The flow rate of nitrogen was 150 sccm, the heating rate was 5° C./min, and the heating temperature was 250° C. Then, the material Ni₂P/NF was obtained after naturally cooling, washing and drying.

The electrochemical test conditions were the same as those in Embodiment 1, and the electrochemical test performance is shown in FIG. 3. The electrochemical test results show that the corresponding overpotential at the current density of 10 mA/cm² was 278 mV, and the corresponding overpotential at the current density of 50 mA/cm² was 320 mV.

Comparative Example 3

Control experiment on electrochemical water oxidation of commercial RuO₂ loaded on NF

5 mg of commercial RuO₂ catalyst was dispersed in 450 μL of water/ethanol (with a volume ratio of 1:3.5) mixed solvent to obtain a mixed solution, and 50 μL of Nafion aqueous solution with a mass fraction of 5% was added into the mixed solution to form a uniform ink-like solution after continuous ultrasonic treatment for 30 min. Then, the prepared catalyst ink-like solution (with an amount of about 1.0 mg/cm²) was dropped on the NF with a size of 0.5×0.5 cm² as a working electrode.

The electrochemical test conditions were the same as those in Embodiment 1, and the electrochemical test performance is shown in FIG. 3. The electrochemical test results show that the corresponding overpotential at the current density of 10 mA/cm² was 294 mV, and the corresponding overpotential at the current density of 50 mA/cm² was 373 mV.

1. A method for preparing a one-dimensional Ni₁₂P₅/Ni₂P polycrystalline heterostructure catalyst used for high-efficiency water oxidation, comprising the following steps of:
S1. putting nickel foam into a HCl solution with a concentration of 1.0-4.0 M for ultrasonic treatment for 20-60 min, then performing ultrasonic washing to the nickel foam in deionized water, ethanol and acetone for 20-40 min in sequence, and drying the washed nickel foam to obtain a clean nickel foam sheet for later use;
S2. putting the nickel foam sheet obtained in step S1 into a (NH₄)₂HPO₄ aqueous solution for solvothermal reaction at a reaction temperature of 170-190° C. for 10-16 h to obtain a reacted nickel foam sheet, naturally cooling the reacted nickel foam sheet to room temperature, washing the reacted nickel foam sheet, drying the reacted nickel foam sheet after washing for 12 h, putting the reacted nickel foam sheet after drying into a NaOH aqueous solution for solvothermal reaction at 100-130° C. for 4-6 h to obtain a reaction product, and then washing and drying the reaction product to obtain a nickel foam sheet with a rough and defective surface for later use; and
S3. mixing NaH₂PO₂·H₂O and the nickel foam sheet with a rough and defective surface obtained in step S2 to obtain a mixture, heating the mixture in a tube furnace at 270-380° C. for 2-3 h under a nitrogen atmosphere to obtain a product after naturally cooling, washing and drying the product to obtain a Ni₁₂P₅/Ni₂P/NF catalyst.

2. The method according to claim 1, wherein in step S1, a size of the nickel foam is 3×3 cm² to 6×6 cm², and the drying conditions are as follows: vacuum drying at 50-70° C. for 24-36 h.

3. The method according to claim 1, wherein in step S2, the (NH₄)₂HPO₄ aqueous solution has a concentration of 1-2 nM, and the NaOH aqueous solution has a concentration of 100-200 nM, and the drying conditions are as follows: vacuum drying at 50-70° C. for 10-16 h.

4. The method according to claim 1, wherein in step S3, a weight ratio of NaH₂PO₂·H₂O to r-NF obtained in step S2 is 9-11:1.

5. The method according to claim 1, wherein in step S3, a flow rate of nitrogen is 100-150 sccm, a heating rate is 5-8° C./min, and the drying conditions are as follows: vacuum drying at room temperature for 12-24 h.

6. The method according to claim 1, wherein potassium hexachloroiridate is dissolved in an ethanol/water mixed solution with a volume ratio of 1:1-2 to prepare an potassium hexachloroiridate solution, the potassium hexachloroiridate solution is drop-coated on the obtained Ni₁₂P₅/Ni₂P/NF catalyst, then the catalyst is heated at 60-90°° C. for 2-4 h, and an Ir—Ni₁₂P₅/Ni₂P/NF catalyst is obtained after naturally cooling.

7. The method according to claim 6, wherein the potassium hexachloroiridate solution has a concentration of 0.02-0.04 mM, and a mass ratio of Ir to Ni₁₂P₅/Ni₂P/NF catalyst in the Ir—Ni₁₂P₅/Ni₂P/NF catalyst is 0.01-0.04:1.

8. An application of the Ni₁₂P₅/Ni₂P/NF catalyst prepared by the method according to claim 1 in electrocatalytic oxygen production.

9. An application of the Irₓ—Ni₁₂P₅/Ni₂P/NF-T catalyst prepared by the method according to claim 6 in electrocatalytic oxygen production.

10. The application according to claim 8, wherein an electrolyte used in the electrocatalytic water splitting reaction is an alkaline electrolyte, a base used in the alkaline electrolyte is one of KOH, NaOH, LiOH and CsOH, preferably KOH, and a concentration of the alkaline electrolyte is 0.5-10 M, preferably 1M.
